(19) United States
(12) Patent Application Publication
(10) Pub. No.: US 2020/0166661 A1
(43) Pub. Date: May 28, 2020

(54) PORTABLE SEISMIC SURVEY DEVICE, SYSTEM AND METHOD

(71) Applicant: Explor Geophysical, Ltd., Calgary (CA)

(72) Inventors: Allan Robert Châtenay, Calgary (CA); Lee Martin, Calgary (CA); Pierce Andrew Laing, Calgary (CA); Todd Machacek, Calgary (CA); Simon Schmitt, Calgary (CA); Cameron Rankin, Calgary (CA)

(73) Assignee: Explor Geophysical, Ltd., Calgary (CA)

(21) Appl. No.: 16/778,320

(22) Filed: Jan. 31, 2020

Related U.S. Application Data
(63) Continuation-in-part of application No. 16/278,799, filed on Feb. 19, 2019.
Application No. 16/278,799 is a continuation of application No. 15/442,870, filed on Feb. 27, 2017, now Pat. No. 10,247,837.

(51) Int. Cl. G01V 1/104; G01V 1/00; E21B 49/00; E21B 47/022; E21B 47/00

(52) U.S. Cl. CPC G01V 1/104; G01V 1/003; E21B 49/00; G01V 2210/1299; E21B 47/0003; G01V 2210/121; E21B 47/02208

(57) ABSTRACT

The present technology is essentially a portable seismic survey system and method using reflection seismology for mapping subterranean formations. The device includes an upper assembly, a firing pin operably associated with a firing pin actuator, a lower assembly including a cartridge holder capable of retaining a blasting cartridge, and a detonation sensor capable of detecting detonation of the blasting cartridge. The system can further include an anchoring assembly, and an adjustable shield assembly. The detonation sensor transmits a signal to an event marking device to trigger a recordation of detonation time and geographic location of the seismic survey device. A seismic wave is generated upon detonation, which is then reflected back toward seismometers. Data from the event marking system and seismometers can then be processed to provide geological formation information.

### CROSS-REFERENCE TO RELATED APPLICATION

This application claims the benefit of priority of and is a continuation-in-part application under 35 U.S.C. § 120 based upon co-pending U.S. patent application Ser. No. 16/278,799, filed on Feb. 19, 2019. The entire disclosure of the prior application is incorporated herein by reference.

### BACKGROUND

### Technical Field

The present technology relates to a portable seismic survey device, system and method for use in connection with reflection seismology for mapping subterranean formations.

### Background Description

It is known in the petroleum, gas, mineral and water exploration industries to use seismic geophysical surveys to map subterranean formations, such as but not limited to: stratigraphy of subterranean formations, lateral continuity of geologic layers, locations of buried paleochannels, positions of faults in sedimentary layers, basement topography, and others. These maps can be deduced through analysis of the nature of reflections and refractions of generated seismic waves from interfaces between layers within the subterranean formation.

Typically, a seismic energy source is used to generate seismic waves that travel through the earth and are then reflected by various subterranean formations to the earth's surface. At the surface, these reflected seismic waves are detected by an array of ground motion sensors, known as seismometers or geophones, which convert the detected waves into electrical signals. The electrical signals are stored and analyzed by a computer modeling system to determine and display the nature of the subterranean formations at a location surrounding the point the seismic waves were generated.

Known seismic energy source devices can be in communication with a global position system (GPS) or other telemetry systems to provide logging of the precise location and time of seismic wave generation. Typically, the seismic energy source device is controlled and activated automatically by the telemetry system, which can present a potential disadvantage since multiple error logs can occur by misfires of the seismic energy source device. Further disadvantage of these known systems is that the user does not having full control of the seismic energy source device since detonation is controlled by the telemetry system.

It has become desirable to extend drilling to locations that are environmentally sensitive or with limited vehicular access, which appear to overlay oil and gas formations. Thus portable seismic energy source devices have been developed and used.

It has been known to use vehicles that transport or tow a seismic source device from location to location. At a given location, the seismic source is placed in direct contact with the ground. The seismic source device is activated to generate a seismic wave. However, the traditional seismic source devices are very heavy and thus need to be deployed by a vehicle, and they typically require large charges for creating a seismic wave that can travel deep through the Earth. As the environmentally sensitive areas prohibit or strictly limit the access of heavy duty equipment or vehicles, the existing methods for generating seismic waves are not suitable for these areas. These large systems are also undesirable for application in shallow wells that span large lateral distances.

Seismic data is critical to oil and gas companies during the exploration and development of oil and gas reserves. Seismic data is used from the earliest point in exploration right through the life of an oil or gas field, and in some cases even after the well has been abandoned. Seismic data is used for many different purposes; broad based analysis of prospective hydrocarbon basins, localized exploration of a prospective area, high resolution imaging prior to drilling a well, throughout the drilling process (including pore pressure prediction and micro-fracture analysis), and to enhance production as a field is developed and optimized throughout its productive life.

While the above-described devices fulfill their respective, particular objectives and requirements, the aforementioned patents do not describe a portable seismic survey system and method that allows reflection seismology for mapping subterranean formations with detonation triggered event marking.

Therefore, a need exists for a new and novel portable seismic survey system and method that can be used for reflection seismology for mapping subterranean formations. In this regard, the present technology substantially fulfills this need. In this respect, the portable seismic survey system and method according to the present technology substantially departs from the conventional concepts and designs of the prior art, and in doing so provides an apparatus primarily developed for the purpose of reflection seismology for mapping subterranean formations.

### BRIEF SUMMARY OF THE PRESENT TECHNOLOGY

In view of the foregoing disadvantages inherent in the known types of seismic source systems now present, the present technology provides a novel portable seismic survey system and method, and overcomes the above-mentioned disadvantages and drawbacks of known types of seismic source systems. As such, the general purpose of the present technology, which will be described subsequently in greater detail, is to provide a new and novel portable seismic survey system and method which has all the advantages of the prior art mentioned heretofore and many novel features that result in a portable seismic survey system and method which is not anticipated, rendered obvious, suggested, or even implied by the prior art, either alone or in any combination thereof.

According to one aspect, the present technology can include a seismic system including a firing pin operably associated with a firing pin actuator slidable in an upper assembly. A lower assembly can include a cartridge holder configured to retain a blasting cartridge so that the firing pin operationally detonates the blasting cartridge. A main tube can connect the upper assembly and the lower assembly. The main tube can be configured to position the upper assembly out of a borehole and to position the cartridge holder in the borehole. A shield assembly can be configured to adjustably move along the main tube.

According to another aspect, the present technology can include a seismic survey system including at least one seismic device, at least one detonation sensor, at least one event marking device, and at least one seismometer. The seismic device can include a firing pin operably associated with a firing pin actuator slidable in an upper assembly. The lower assembly can include a cartridge holder configured to retain a blasting cartridge so that the firing pin operationally detonates the blasting cartridge. A main tube can connect the upper assembly and the lower assembly. The main tube can be configured to position the upper assembly out of a borehole and to position the cartridge holder in the borehole. A shield assembly can be configured to adjustably move along the main tube. The detonation sensor can be configured to detect a detonation condition of the blasting cartridge. The event marking device can be in communication with the detonation sensor. The seismometer can be configured to detect a seismic condition created by the detonation condition of the blasting cartridge.

According to still another aspect, the present technology can include a seismic system comprising a firing pin can be operably associated with a firing pin actuator slidable in an upper assembly. A lower assembly can include a cartridge holder configured to retain a blasting cartridge so that the firing pin can operationally detonate the blasting cartridge. A main tube can connect the upper assembly and the lower assembly. The main tube can be configured to position the upper assembly out of a borehole and to position the cartridge holder in the borehole. An anchor assembly can be associated with the upper assembly or the main tube. The anchor assembly can be configured to provide a hold down or lifting force to the upper assembly or the main tube.

According to yet another aspect, the present technology can include a seismic system comprising a firing pin can be operably associated with a firing pin actuator slidable in an upper assembly. A lower assembly can include a cartridge holder configured to retain a blasting cartridge so that the firing pin can operationally detonate the blasting cartridge. A main tube can connect the upper assembly and the lower assembly. The main tube can be configured to position the upper assembly out of a borehole and to position the cartridge holder in the borehole. An anchor assembly can be associated with the upper assembly or the main tube. The anchor assembly can be configured to provide a hold down or lifting force to the upper assembly or the main tube. A shield assembly configured to adjustably move along the main tube.

According to yet still another aspect, the present technology can include a method of using a seismic system including the steps of inserting a lower assembly of a seismic device into a borehole, with an upper assembly being connected to the lower assembly by way of a main tube. Adjusting a position of a shield assembly along the main tube so that a cartridge holder associated with the lower assembly is at a depth in the borehole. Operating a firing pin actuator that is slidably located in an upper assembly of the seismic device to move a firing pin. Detonating a blasting cartridge positioned inside the cartridge holder using the firing pin. Detecting detonation of the blasting cartridge using a detonation sensor. Transmitting a signal from the detonation sensor to an event marking device that is configured to record a detonation time and a geographic location of the seismic device upon receipt of the signal.

There has thus been outlined, rather broadly, features of the present technology in order that the detailed description thereof that follows may be better understood and in order that the present contribution to the art may be better appreciated.

In some embodiments of the present technology, the shield assembly can further comprise a shield attachable to a shield clamp member, and a shield handle attachable to the shield clamp member.

In some embodiments of the present technology, the shield clamp member can be configured to releasably clamp against the main tube.

In some embodiments of the present technology, the shield handle can include an opening configured to slidably receive the main tube.

Some embodiments of the preset technology can include at least one detonation sensor operably connected with the firing pin actuator. The detonation sensor can be configured to detect a detonation condition of the blasting cartridge.

In some embodiments of the present technology, the upper assembly can define at least one J-shaped slot configured to slidably receive a portion of a sensor holder including the detonation sensor.

In some embodiments of the present technology, the firing pin actuator can define a lock pin bore and a sensor bore. The lock pin bore can be configured to receive a lock pin biased toward a sensor holder. The sensor holder can be configured to receive the detonation sensor and to be received in the sensor bore.

In some embodiments of the present technology, the firing pin actuator can define a firing pin bore configured to receive a first end portion of the firing pin, and at least one setscrew bore defined through the firing pin actuator lateral and in communication with the firing pin bore. A setscrew can be receivable in the setscrew bore and can be configured to contact an annular groove defined in the firing pin when the first end portion of the firing pin is located in the firing pin bore.

Some embodiments of the present technology can include one or more anchors tethered to the upper assembly or the main tube by way of a strap. The anchor assembly can be configured to provide a hold down force or a lifting force to the upper assembly or the main tube. The anchor assembly can be configured to provide the hold down force when a weight is applied to the anchor.

Some embodiments of the present technology can include a mounting collar including a longitudinal bore configured to slidably receive the firing pin therethrough, a mounting collar first end connectable to a second end of the upper assembly, and a mounting collar second end connectable to a first end of the main tube.

Some embodiments of the present technology can include an anchor mount assembly including an anchor clamp member, at least one handle extending from or attachable to the anchor clamp member, and at least one strap mount rotatably or pivotably connectable to the anchor mount. The strap can be operably connected to the strap mount and the anchors, respectively.

In some embodiments of the present technology, the anchor clamp member can be configured to releasably clamp against the mounting collar.

In some embodiments of the present technology, the anchors are a strap or loop configured to receive a foot or hand of a user.

Some embodiments of the present technology can include a lower tube attachable to the main tube. The lower tube can include a first end section configured to receive and guide at least a portion of the firing pin, and a firing chamber configured to receive at least a portion of the cartridge holder.

Some embodiments of the present technology can include at least one event marking device in communication with the detonation sensor. The event marking device can be configured to determine a detonation time and a geographic location of the seismic survey device upon receipt of a signal from the detonation signal of a detonation condition of the blasting cartridge.

Some embodiments of the present technology can include at least one seismometer configured to detect a seismic condition created by the detonation condition of the blasting cartridge.

Additional aspects of the present technology can include a seismic survey device or system including an upper assembly, a firing pin operably associated with a firing pin actuator, a lower assembly including a cartridge holder, and a detonation sensor. The cartridge holder can have a configuration capable of retaining a blasting cartridge so that the firing pin is capable of operationally detonating the blasting cartridge. The detonation sensor is capable of detecting a detonation condition of the blasting cartridge.

In some embodiments of the present technology, at least one tube can be attached to the upper assembly, with the lower assembly attachable to the tube. The firing pin can be slidably receivable in the tube.

In some embodiments of the present technology, the upper assembly can further define an internal cavity and at least one longitudinal slot in communication with the internal cavity. The longitudinal slot can have a configuration capable of slidably receiving a portion of a sensor holding assembly. A portion of the detonation sensor can be associated with the sensor holding assembly. The firing pin actuator can be slidably received in the internal cavity.

In some embodiments of the present technology, the sensor holding assembly can include an actuator handle featuring the portion slidably receivable in the longitudinal slot. The actuator handle can define an actuator handle cavity with a configuration capable of receiving at least a portion of the detonation sensor.

In some embodiments of the present technology, the firing chamber can further define an internal firing chamber cavity in communication with the firing chamber bore. The internal firing chamber cavity can have a configuration capable of receiving at least a portion of the cartridge holder.

The present technology may also include a lower tube attachable to the main tube and the firing chamber. The lower tube can include channels defined in an external surface thereof.

Still further, the present technology may include at least one foot support assembly and/or at least one handle.

The present technology may further include at least one firing pin guide attachable to the firing pin. The firing pin guide can have a configuration capable of being slidably received in the main tube or the lower tube.

According to yet another aspect, the present technology can include a seismic survey system including a portable device configured to create a seismic wave, at least one sensor, and an event marking device. The sensor can be configured to detect a creation condition of the seismic wave and to generate a signal associated with creation of the seismic wave upon detecting of the creation condition. The event marking device can be configured to receive the signal, to determine a time associate with the creation of the seismic wave, and a geographic location of the portable device upon triggering by receipt of the signal.

According to another aspect, the present technology can include a method of using a seismic survey system. The method including creating a seismic wave at a geographic location utilizing a portable device. Detecting creation of the seismic wave using a sensor. Communicating a signal from the sensor to an event marking device. Triggering by receipt of the signal a recordation by the event marking device of a time associated with creation of the seismic wave and a geographic location of the portable device.

According to still another aspect, the present technology can include a method of using a seismic survey system. The method can include determining a borehole depth based on at least one soil condition of a location of at least one borehole. Drilling the borehole to the determined borehole depth. Providing location of detonation at least one portable device configured to retain and detonate a blasting cartridge. Detonating the blasting cartridge inside the borehole. Detecting detonation of the blasting cartridge using a detonation sensor. Communicating a signal from the detonation sensor to an event marking device. Triggering by receipt of the signal a recordation by the event marking device of a detonation time and a geographic location of the portable device.

In some embodiments, the seismometer can include a global positioning unit, the seismometer can be configured to communicate geographic location information of the seismometer to the event marking device or the recording system.

In some embodiments, the seismometer can be a plurality of seismometers positioned at locations in or on a surface of a geographic area.

Some embodiments of the present technology can include a soil sensing device associated with the portable device. The soil sensing device can be configured to sense a condition selected from the group consisting of soil moisture, photosynthetically active radiation (PAR) at soil surface, soil temperature, soil respiration, soil heat flux, solar radiation, gas detection, radiation, PH level, and geochemical measurements.

In some embodiments, the detonation sensor can be configured to communicate the detonation signal to the event marking device wirelessly or by way of wiring.

In some embodiments, the portable device can include a global positioning unit that is configured to provide geographic location information to the event marking device.

Some embodiments of the present technology can include a location antenna attachable to an upper assembly of the portable device.

In some embodiments, the blasting cartridge can be detonated at a depth below a surface of the earth.

In some embodiments, the depth can be based on at least one soil condition of a location of detonation.

Some embodiments of the present technology can include the step of detecting the seismic wave or a reflection of the seismic wave by one or more seismometers, and generating by the seismometers a reception time.

Some embodiments of the present technology can include the step of communicating to a recording system the detonation time from the event marking device, and the reception time from the seismometers.

Some embodiments of the present technology can include the step of processing by the recording system at least the detonation time and the reception time to provide geological formation information.

Some embodiments of the present technology can include the step of communicating to the recording system geographic location information of the portable device and the seismometers, and processing the geographic location information for utilization in providing the geological formation information.

There are, of course, additional features of the present technology that will be described hereinafter and which will form the subject matter of the claims attached.

Numerous objects, features and advantages of the present technology will be readily apparent to those of ordinary skill in the art upon a reading of the following detailed description of the present technology, but nonetheless illustrative, embodiments of the present technology when taken in conjunction with the accompanying drawings.

As such, those skilled in the art will appreciate that the conception, upon which this disclosure is based, may readily be utilized as a basis for the designing of other structures, methods and systems for carrying out the several purposes of the present technology. It is, therefore, that the claims be regarded as including such equivalent constructions insofar as they do not depart from the spirit and scope of the present technology.

It is therefore an object of the present technology to provide a new and novel portable seismic survey system and method that has all the advantages of the prior art seismic source systems and none of the disadvantages.

It is another object of the present technology to provide a new and novel portable seismic survey system and method that may be easily and efficiently manufactured and marketed.

An even further object of the present technology is to provide a new and novel portable seismic survey system and method that has a low cost of manufacture with regard to both materials and labor, and which accordingly is then susceptible of low prices of sale to the consuming public, thereby making such portable seismic survey system and method economically available to the buying public.

Still another object of the present technology is to provide a portable seismic survey system and method for reflection seismology for mapping subterranean formations. This allows for the portability of the seismic survey device that controls and triggers the event marking device at the time of detonation.

These together with other objects of the present technology, along with the various features of novelty that characterize the present technology, are pointed out with particularity in the claims annexed to and forming a part of this disclosure. For a better understanding of the present technology, its operating advantages and the specific objects attained by its uses, reference should be made to the accompanying drawings and descriptive matter in which there are illustrated embodiments of the present technology.

### BRIEF DESCRIPTION OF THE DRAWINGS

The present technology will be better understood and objects other than those set forth above will become apparent when consideration is given to the following detailed description thereof. Such description makes reference to the annexed drawings wherein:

FIG. 1 is a perspective view of an embodiment of the portable seismic survey system and method constructed in accordance with the principles of the present technology, with the phantom lines depicting environmental structure and forming no part of the claimed present technology.

FIG. 2 is a perspective view of the portable seismic survey device of the present technology.

FIG. 3 is an exploded perspective view of the upper assembly of the present technology.

FIG. 4 is an exploded perspective view of the firing weight and piezo holder assembly of the present technology.

FIG. 5 is a cross-sectional view of the upper assembly taken along line 5-5 in FIG. 2.

FIG. 6 is an exploded perspective view of the foot support assembly of the present technology.

FIG. 7 is a cross-sectional view of the foot support assembly taken along line 7-7 in

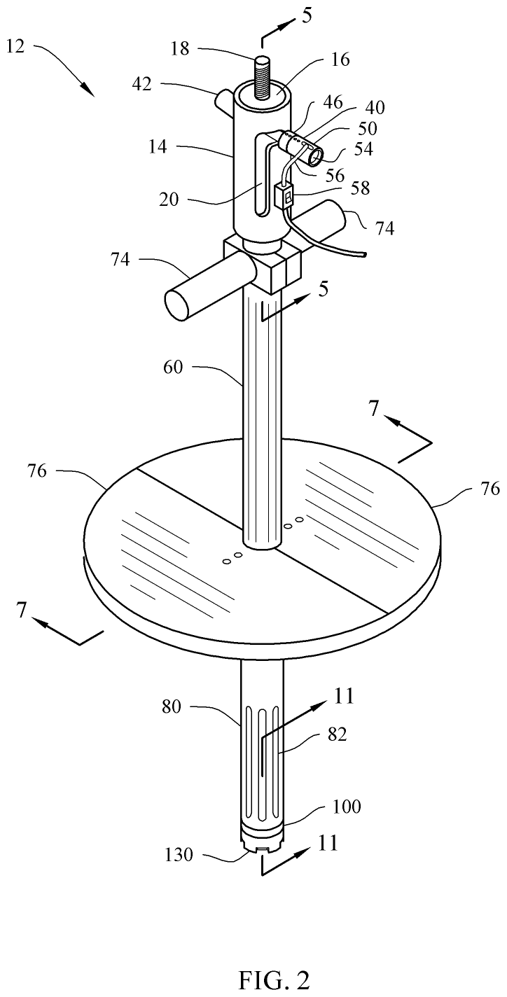

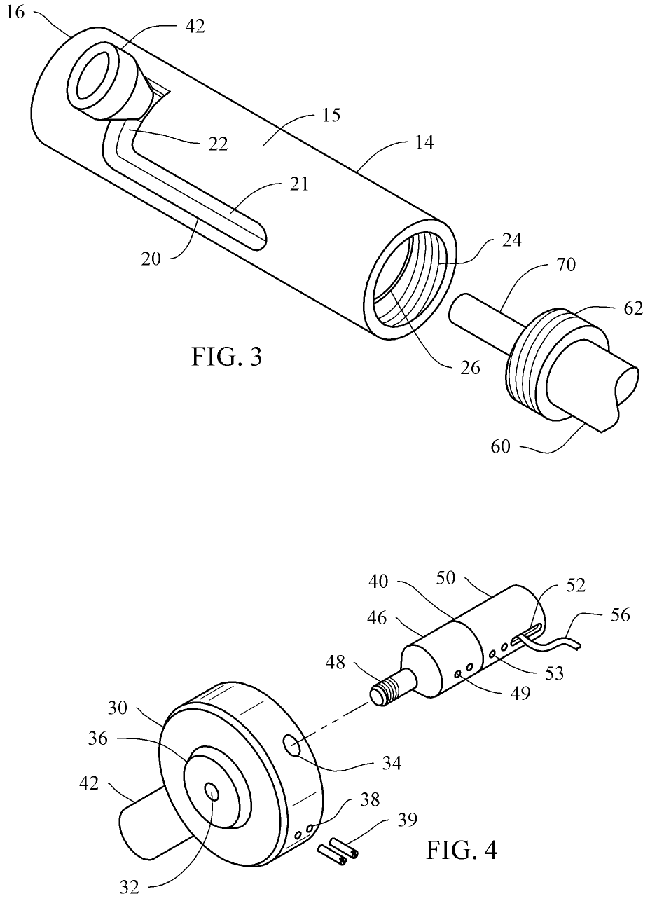

FIG. 2.

FIG. 8 is an exploded perspective view of the lower assembly, the firing pin guide, the firing pin, the firing chamber and the shot holder of the present technology.

FIG. 9 is a cross-sectional view of the firing chamber of the present technology.

FIG. 10 is a cross-sectional view of the shot holder with an exploded cartridge of the present technology.

FIG. 11 is a cross-sectional view of the lower assembly taken along line 11-11 in FIG. 2.

FIG. 12 is a front plane view of the shot holder tool of the present technology.

FIG. 13 is a perspective view of an embodiment of the portable seismic survey system and method constructed in accordance with the principles of the present technology, with the phantom lines depicting environmental structure and forming no part of the claimed present technology.

FIG. 14 is an exploded perspective view of the upper assembly of the present technology.

FIG. 15 is cross-sectional view of the upper assembly of the present technology taken along line 15-15 in FIG. 14.

FIG. 15a is an enlarged cross-sectional view of the spring-loaded lock pin taken from FIG. 15.

FIG. 16 is an exploded perspective view of the foot strap mounting collar of the present technology.

FIG. 17 is cross-sectional view of the foot strap mounting collar assembly of the present technology taken along line 17-17 in FIG. 13.

FIG. 18 is cross-sectional view of the handle clamp assembly of the present technology taken along line 18-18 in FIG. 17.

FIG. 19 is cross-sectional view of the adjustable shield clamp assembly of the present technology taken along line 19-19 in FIG. 13.

FIG. 20 is cross-sectional view of the adjustable shield clamp assembly of the present technology taken along line 20-20 in FIG. 19.

FIG. 21 is a cross-sectional view of the lower assembly taken along line 21-21 in FIG. 13.

FIG. 22 is an enlarged perspective view of the foot strap of the present technology.

The same reference numerals refer to the same parts throughout the various figures.

### DETAILED DESCRIPTION OF THE PRESENT TECHNOLOGY

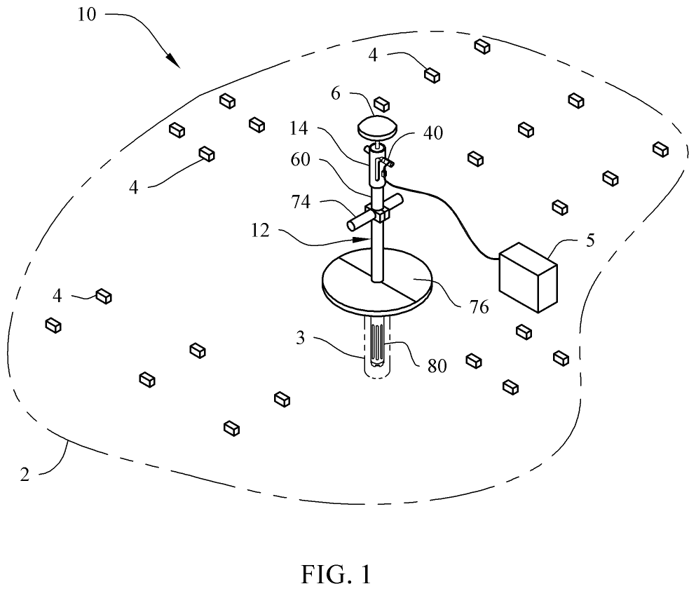

Referring now to the drawings, and particularly to FIGS. 1-22, an embodiment of the portable seismic survey system and method of the present technology is shown and generally designated by the reference numeral 10.

In FIG. 1, a new and novel portable seismic survey system and method 10 of the present technology for reflection seismology intended for mapping subterranean formations is illustrated and will be described. To collect seismic survey data in a field 2 to be surveyed, a plurality (tens, hundreds or thousands) of ground seismometers 4 can be positioned at predetermined locations in or on the field 2. The most commonly used seismometer 4 can be a small, portable single component geophone that is planted into the earth and which converts vertical ground motion into a small analog electrical signal. Of late, such sensors have been manufactured with GPS receivers locally coupled to the sensor as well as a battery and sufficient memory to record the signals detected by each sensor continuously for a period of several weeks.

It can be appreciated that more sensitive digital sensing units, which can sense ground motion in three dimensions, can be used with the present technology thereby providing better seismic data and new opportunities for sub-surface imaging.

Ground motion can then be created with small explosive charges positioned inside a borehole 3 drilled into the surface of the earth at a variable angle and/or a depth that can be variably determined based on local conditions using a portable seismic source device 12. The angle of the borehole 3 can be configured to facilitate generation of shear waves. The timing and position of these seismic sources should be very accurate, timed to the fraction of a millisecond, with positions accuracies ranging from with 5 metres to less than a metre depending on the geophysical acquisition objectives.

As the seismic waves of ground motion created by the seismic source device 12 travels through the earth, they reflect and refract off subsurface geological layers. At the boundary between each geological layer, some energy will be reflected and the rest of the energy will continue through the boundary. As these reflected and refracted signals are detected by the seismometers 4 at the surface, they are either recorded locally into the digital memory coupled to the sensor or they are transmitted either via cable or wireless transmission to a central recording system (not shown) that records all of the reflected ground motion detected by all of the seismometers 4 at the surface.

By processing these data, a highly detailed image of subsurface layers of the field 2 can be created. This enables geophysicists, geologists and engineers to interpret and understand the subsurface layers with advantages over other imaging technology.

More particularly, the seismic source device 12 can be in communication with a GPS event marking device 5 that is in communication with a GPS or location antenna 6 that can be mounted to a threaded stud 18 at the top of seismic source device 12. The GPS event marking device 5 can be, but not limited to, a Leica GS25 GNSS instrument or similar device, that can be portable and/or worn on a backpack. The GPS event marking device 5 can be in communication with the central recording system in real time or event data can be uploaded to the central recording system at a later time.

As best illustrated in FIG. 2, the seismic source device 12 can include an upper assembly 14, a sensor holding assembly 40, a main tube 60, a foot support assembly 76 and a lower tube 80. The lower tube 80 can have a ground insertion portion with an end including a firing chamber 100 and a cartridge holder 130. It can be appreciated that the firing chamber 100 and cartridge holder 130 may be attached directly to the main tube 60, without the use of the lower tube 80. It can also be appreciated that the length of main tube 60 and lower tube 80 as well as the position and diameter of foot support assembly 76 can be varied to account for different desired hole depths and local conditions.

Referring to FIG. 3, the upper assembly 14 can include a tubular housing 15 defining a hollow interior or internal cavity, and featuring a first end 16 closed off with an attachable end cap 17 and the threaded stud 18, and a second end 24. The threaded stud 18 can be threadably engageable with the end cap 17, with an end of the threaded stud 18 being receivable in the hollow interior. The threaded stud 18 can include a hook end for hanging the seismic source device 12 or additional peripheral devices can be threadably attached to the threaded stud 18. The threaded stud 18 can further include a quick release mechanism for fitting the peripheral system and/or the GPS antenna 6 thereto. A jam nut and lock washer can be threadably engaged with the threaded stud 18 to more securely attach the threaded stud 18 in position and prevent rotation thereof.

A pair of guide slots 20 can be defined through the tubular housing 15 opposite each other, with the guide slots 20 being in communication with the hollow interior. The guide slots 20 can include a longitudinal slot 21 substantially parallel with a longitudinal axis of the upper assembly 14, and a lateral slot 22.

The second end 24 can be annularly notched or recessed to define a diameter greater than the hollow interior thereby creating an upper assembly ledge 26. The second end 24 can include internal threading or other engagement means.

The main tube 60 defines a hollow interior capable of freely receiving a firing pin 70 therethrough, and a flanged first end 62. The flanged first end 62 has a configuration capable of being received in the second end 24 and capable of abutting against the upper assembly ledge 26 when fully assembled. The flanged first end 62 can further include external threading or engagement means capable of engaging with the internal threading of the second end 24, thereby connecting the upper assembly 14 and the main tube 60 together.

Referring to FIG. 4, a firing pin actuator 30 can be a firing weight that can have a configuration capable of being slidably receivable in the hollow interior of the upper assembly 14. The firing weight 30 can include a bore 32 defined parallel with a longitudinal axis of the firing weight 30, which is capable of receiving a first end portion of the firing pin 70. The firing weight 30 can further include a pair of handle bores 34 opposite each other and lateral to the bore 32, and an extended end portion 36. The extended end portion 36 can feature tapered sides.

It can be appreciated that the firing pin actuator 30 can be in the alternative, but not limited to, a biasing element, a linear drive means or a rotary drive means, which is capable of advancing and/or retracting the firing pin 70.

The portion of the firing pin 70 received in the bore 32 is secured in place by at least one set screw 39 threadably engaged with at least one set screw bore 38 defined laterally and in communication with the bore 32. The set screw 39 is capable of contacting an external surface of the firing pin 70 thereby securing the firing pin 70 and the firing weight 30 together. The firing pin 70 can be pitted for nesting of the set screw 39, or a hole can be defined through the firing pin 70 to receive the set screw 39, or even still the firing pin 70 can be textured to create a gripping force with the set screw 39 and/or the surface of the actuator 30 that defines the bore 32.

A first actuator handle 42 includes a threaded end 44 capable of engaging with one of the handle bores 34, wherein the threaded end 44 can have a configuration capable of being slidably received through one of the guide slots 20.

The sensor holding assembly 40 can include a second actuator handle 46 featuring a threaded end 48 capable of engaging with the other of the handle bores 34, wherein the threaded end 48 can have a configuration capable of being slidably received through the other of the guide slots 20. The second actuator handle 46 can include a recess with a configuration capable of receiving at least a first end portion of a detonation sensor 54. At least one set screw can be threadably engageable with a set screw bore 49 defined laterally through the second actuator handle 46 so as to secure the first end portion of the detonation sensor 54 to the second actuator handle 46. It can be appreciated that the first actuator handle 42 and second first actuator handle 46 are identical, thereby simplifying manufacturing and assembly.

Alternatively, a sensor holder 50 can be used for additional securement of the detonation sensor 54. The sensor holder 50 can include a tubular housing featuring a hollow interior, and a wiring slot 52 parallel with a longitudinal axis of the sensor holder 50. The hollow interior of the sensor holder 50 can have a configuration capable of receiving a second end portion of the detonation sensor 54, with wiring 56 of the detonation sensor 54 being passed and slidably received through wiring slot 52. At least one set screw can be threadably engageable with a set screw bore 53 defined laterally through the sensor holder 50 so as to secure the second end portion of the detonation sensor 54 to the sensor holder 50.

The detonation sensor 54 can be any sensing device that is capable of sensing an operational condition of the seismic source device 12. The detonation sensor 54 can be, but not limited to, a piezoelectric sensor that uses the piezoelectric effect to measure changes in pressure, acceleration, temperature, strain, or force by converting them to an electrical signal. The detonation sensor 54 can also be, alone or in combination, an acoustical sensor, an impact sensor, a thermal sensor, electrical contact switch (coupled with a battery) and the like. This electrical signal can then be communicated to the GPS event marking device 5 via the wiring 56 or wirelessly. The detonation sensor 54 is configured to detect an operational condition of the seismic source device 12, so as to trigger an event marking with the GPS event marking device 5.

A switch 58 can be associated with the wiring 56 to control voltage or signal transmission from the detonation sensor 54 to the GPS event marking device 5. Interrupting voltage or signal transmission from the detonation sensor 54 can avoid unintentional recording and/or event marking by the GPS event marking device 5. It can be appreciated that switch 58 could be augmented with or replaced by with an electronic device capable of eliminating spurious electrical impulses originating from detonation sensor 54. Such a device could also record characteristics of those electrical impulses such as the voltage level, timing of the rise or fall in voltage, and so forth.

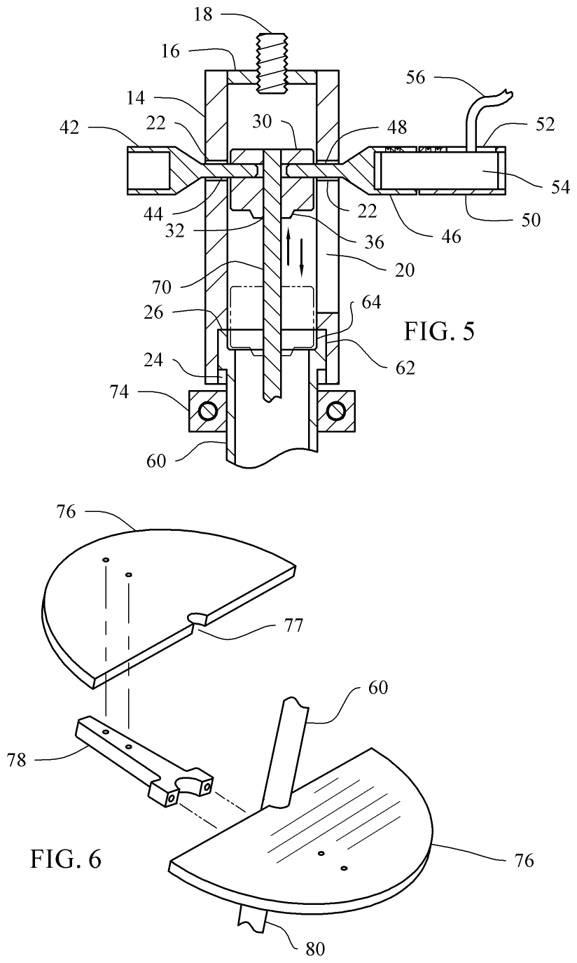

As best illustrated in FIG. 5, the flanged first end 62 of the main tube 60 can include an internally defined annular recess 64 capable of receiving an end portion of the firing weight 30 so that at least the extended end portion 36 of the firing weight 30 is receivable in the hollow interior of the main tube 60. The recess 64 has a diameter greater than the diameter of the main tube hollow interior, thereby creating an annular ledge lateral to the main tube hollow interior.

Thus it can be appreciated that the detonation sensor 54 can be secured to the second actuator handle 46 and the piezo holder 50 exterior of the upper assembly 14, with the second actuator handle 46 being securable to the firing weight 30 located in the hollow interior of the upper assembly 14. Longitudinal movement of the firing weight 30 and firing pin 70 are dependent upon the location of the first and second actuator handle 42, 46 in relation with the guide slots 20, respectively. Specifically, the firing weight 30 and the firing pin 70 can move in a direction parallel with the longitudinal axis of the upper assembly 14 only when the threaded ends 44, 48 of the first and second actuator handles 42, 46 are in the longitudinal slot 21 of the guide slots 20, respectively. Further movement of the firing weight 30 is prohibited when the firing weight 30 contacts the annular ledge that defines the recess 64.

It can be appreciated that the length of the longitudinal slot 21 and/or the distance of the annular ledge defining the recess 64 from the lateral slot 22 determines the travel distance of the firing weight 30 and firing pin 70.

The lateral slot 22 of the guide slots 20 illustrated in FIG. 3 may contain other features that are also within the scope of the present technology. For example, one feature of the present technology is a safety slot (not shown) that extends from the lateral slot 22 in a direction parallel with the longitudinal slot 21. The safety slot can receive the threaded ends 44, 48 of the first and second actuator handles 42, 46 in a locked position thereby preventing accidental movement into the longitudinal slot 21 and preventing unwanted dropping of the firing weight 30 and firing pin 70. Additionally, locking features can be implemented with the guide slot 20 and/or at least one of the actuator handles 42, 46 to prevent unwanted dropping of the firing weight 30 and firing pin 70.

A pair of handles 74 can be attachable to the main tube 60 by way of a clamping bracket. The clamping bracket of each of the handles 74 can be coupled together via fasteners or quick release mechanism to produce a clamping force against the main tube 60. It can be appreciated that the handles 74 can be adjustably secured along the main tube 60 at any desired location and/or orientation.

Referring to FIG. 6, the foot support assembly 76 can include a pair of semicircular plates each defined a bore 77 capable of receiving the main tube 60 therethrough. Each plate 76 is securable to a foot plate support 78. Each foot plate support 78 can include a foot support clamping bracket, which can be coupled together via fasteners or quick release mechanism to produce a clamping force against the main tube 60. It can be appreciated that the foot support assembly 76 can be adjustably secured along the main tube 60 at any desired location and/or orientation.

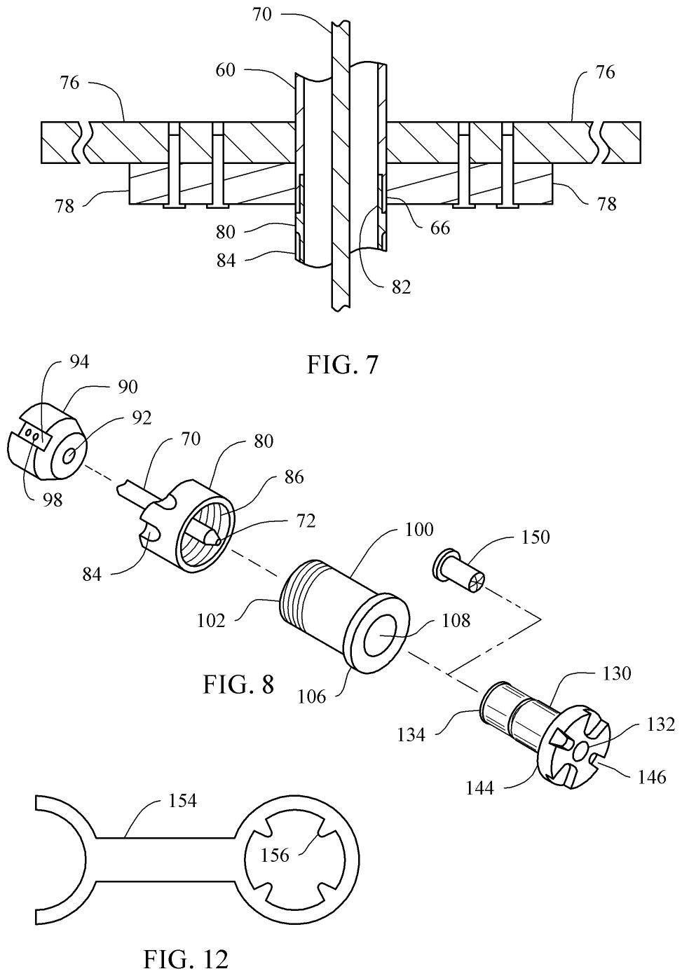

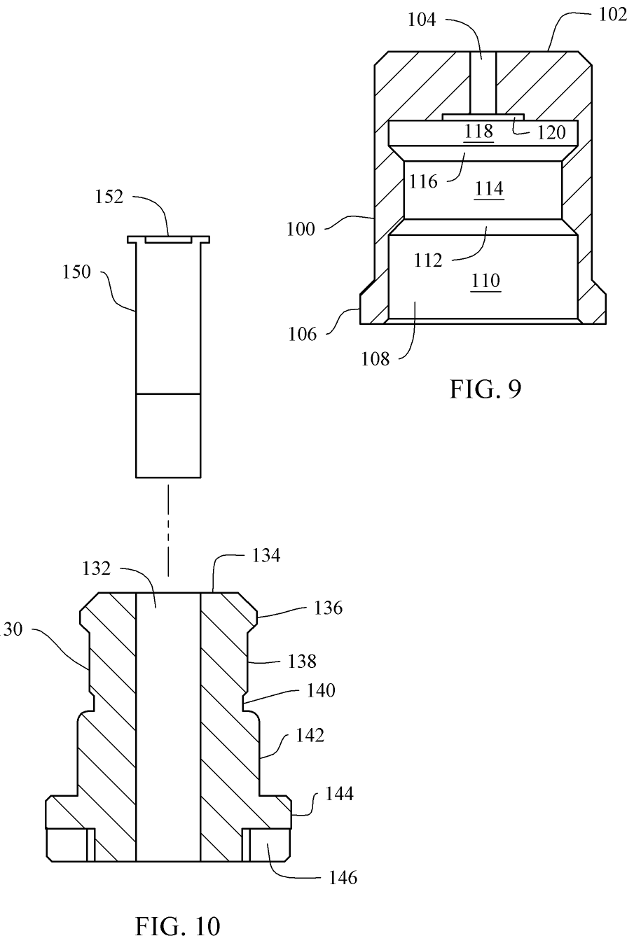

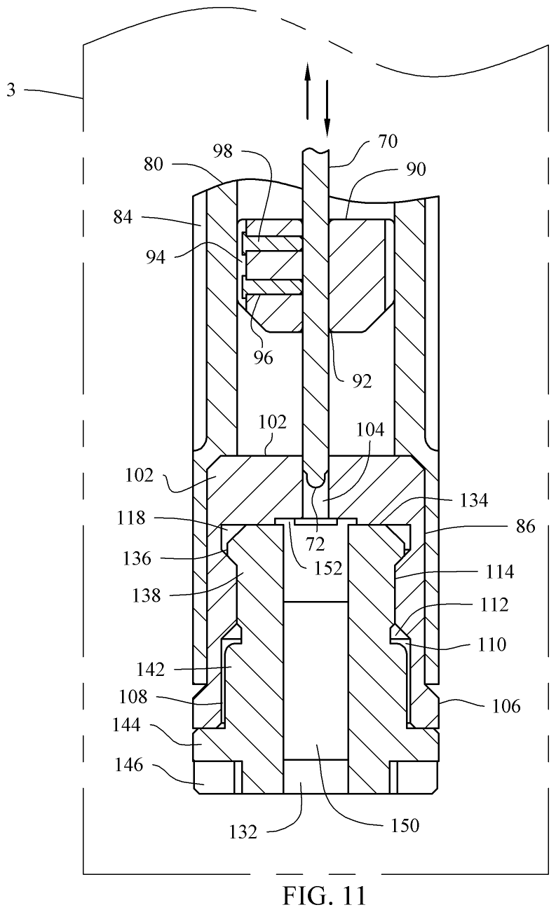

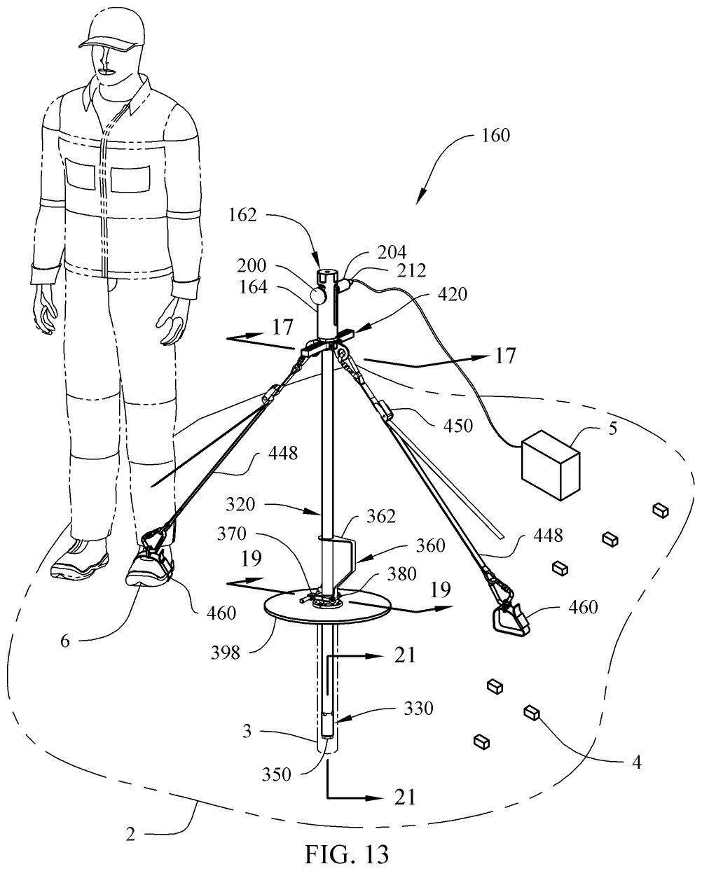

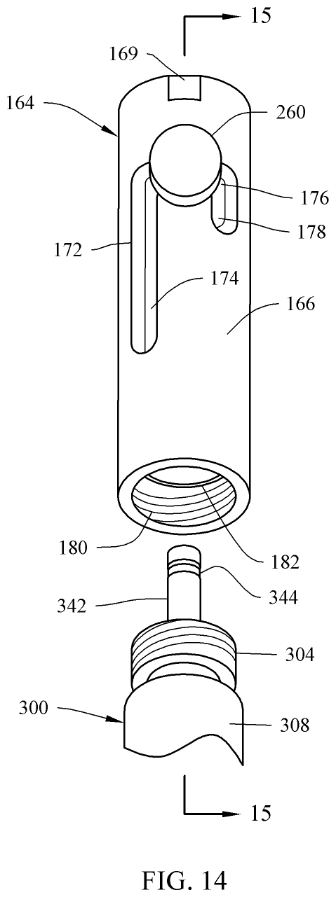

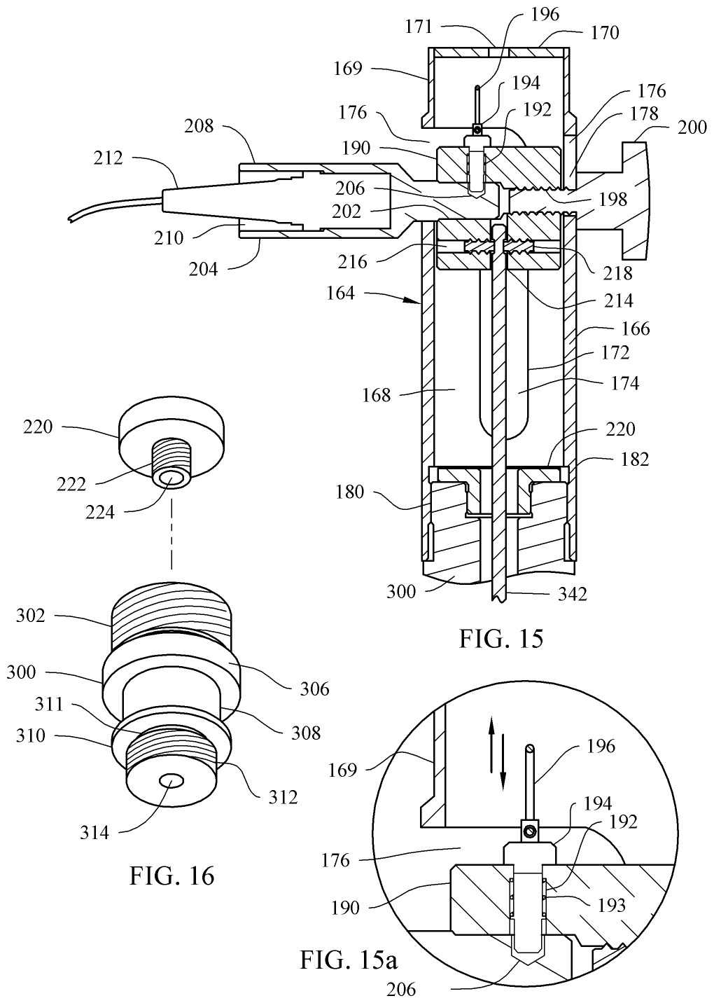

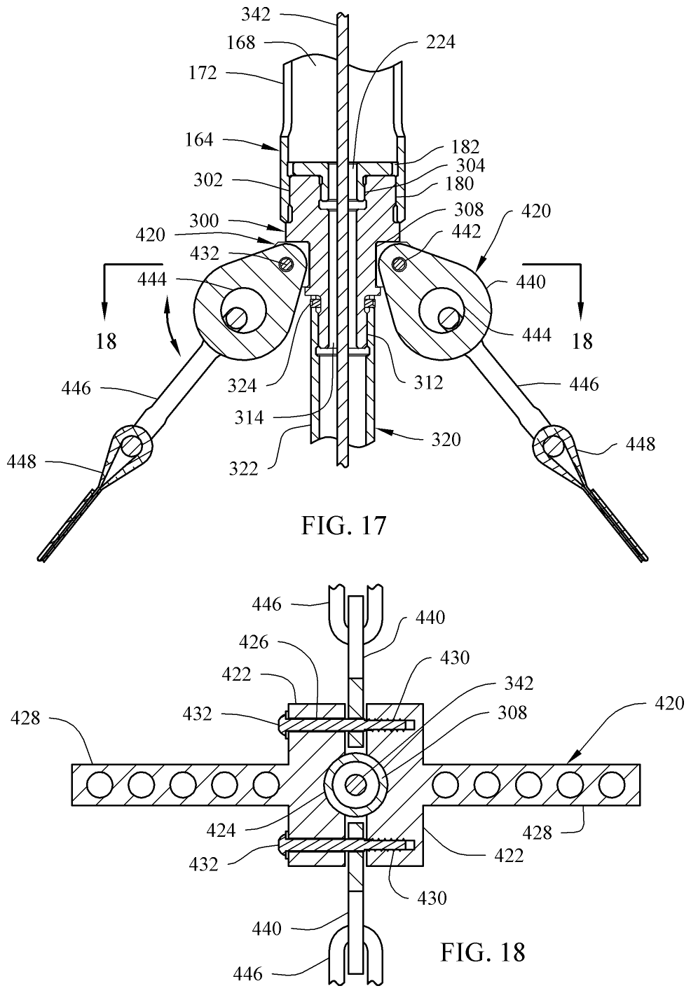

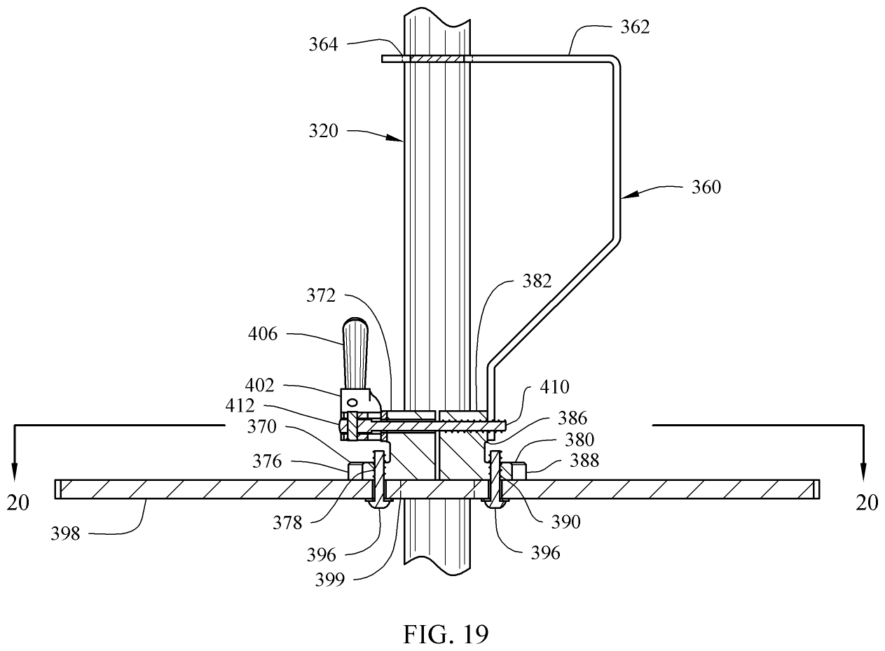

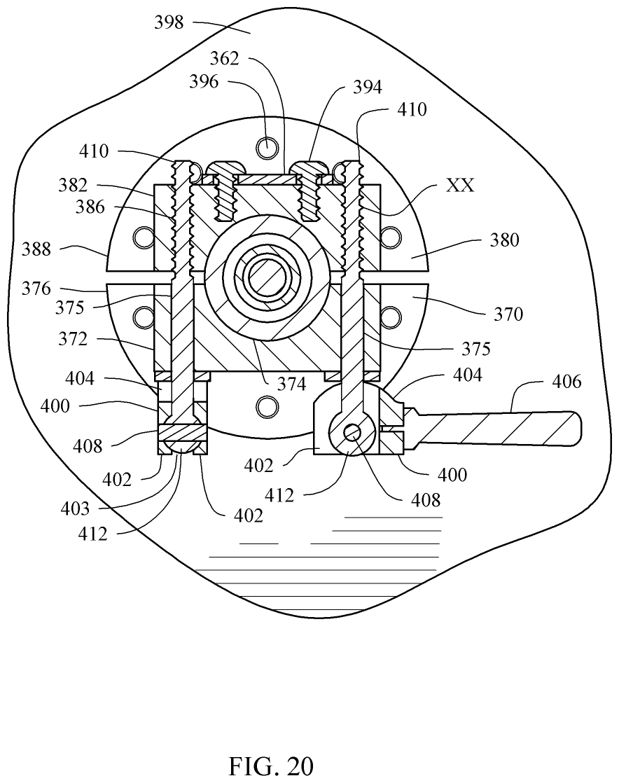

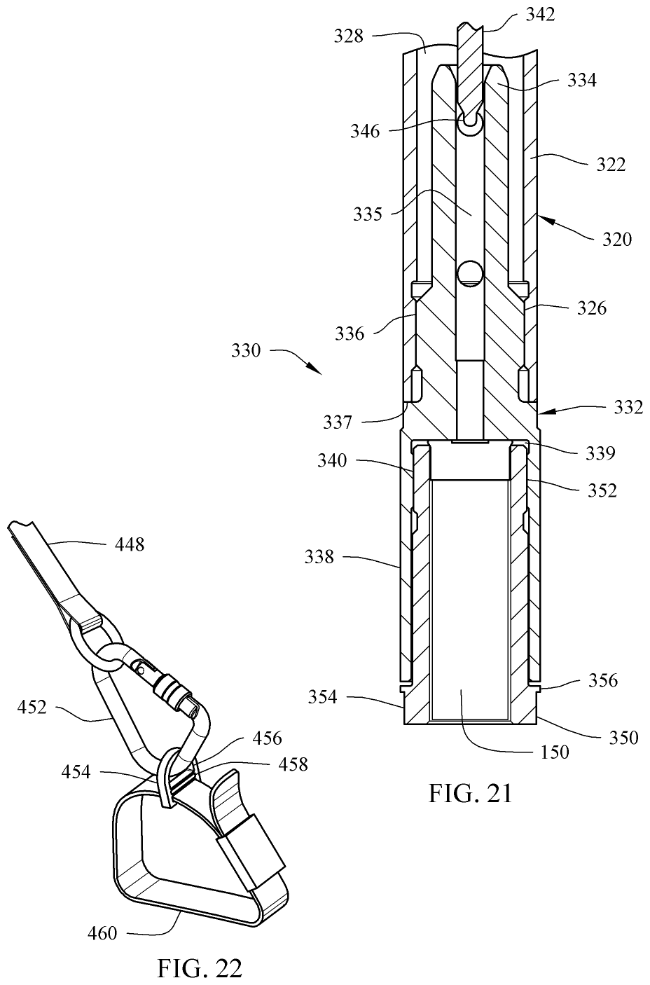

Turning to FIG. 7, the main tube 60 can include a second end 66 featuring an internally defined annular recess capable of engageably receiving a first end 82 of the lower tube 80. The lower tube 80 includes a hollow interior capable of freely receiving the firing pin 70 therethrough. It can be appreciated that the second end 66 of the main tube 60 and the first end 82 of the lower tube 80 can be configured so as to form a flush interior and/or exterior connection between the main tube 60 and the lower tube 80.

The lower tube 80 can include a plurality of channels 84 defined in an external surface thereof, as best illustrated in FIGS. 1, 2 and 12. The channels 84 prevent a vacuum from being created when inserting and/or removing the lower tube 80 in/from the ground. It can be appreciated that the lower tube 80 can include one or more soil sensing devices such as to sense, but not limited to, soil moisture, photosynthetically active radiation (PAR) at soil surface, soil temperature, soil respiration, soil heat flux, solar radiation, gas detection, radiation, PH level, geochemical measurements and the like.

As generally shown in FIG. 8, the lower tube assembly includes the lower tube 80, a firing chamber 100 attachable to the lower tube 80, and a cartridge holder 130 attachable to the firing chamber 100. A blasting cartridge 150 is loadable in an end of the cartridge holder 130.

As best illustrated in FIGS. 8 and 11, the lower tube 80 features a second end 86 that can include an internal annular notch or recess with a diameter greater than the hollow interior of lower tube 80 thereby creating a lower tube ledge. The second end 86 can include internal threading or other engagement means.

The firing pin 70 is freely received through the hollow interview of the lower tube 80, so that a firing tip 72 located at a free end of the firing pin 70 is receivable in the firing chamber 100. At least one firing pin guide 90 can be secured to the firing pin 70 to guide its movement within the main tube 60 and/or the lower tube 80. The firing pin guide 90 has a configuration capable of being slidably received within the hollow interior of the main tube 60 or the lower tube 80. A bore 92 is defined through the firing pin guide 90 parallel to its longitudinal axis, with the bore 92 being capable of receiving therethrough a portion of the firing pin 70.

The portion of the firing pin 70 received in the bore 92 is secured in place by at least one set screw 98 threadably engaged with at least one set screw bore 96 defined laterally and in communication with the bore 92. The set screw 98 is capable of contacting an external surface of the firing pin 70 thereby securing the firing pin 70 and the firing pin guide 90 together. The firing pin 70 can be pitted for nesting of the set screw 98, or a hole can be defined through the firing pin 70 to receive the set screw 98, or even still the firing pin 70 can be textured to create a gripping force with the set screw 98 and/or the surface of the firing pin guide 90 that defines the bore 92.

A notch 94 is defined along an external surface of the firing pin guide 90 to accommodate a head or protrusion of the set screw 98, thereby preventing the head or protrusion of the set screw 98 from contacting the internal surface of the main tube 60 or the lower tube 80.

As best illustrated in FIGS. 9 and 11, the firing chamber 100 includes a first end 102 defining a first end bore 104 capable of slidably receiving therethrough the firing tip 72, and a flanged second end 106. An external portion of the firing chamber 100 can include external threading or other engagement means capable of engaging with the internal threading of the second end 86 of the lower tube 80 or the second end 66 of the main tube 60, thereby connecting the lower tube 80 or main tube 60 and the firing chamber 100 together. The first end 102 has a configuration capable of abutting against the ledge created by the recessed second end 86 when fully assembled.

It can be appreciated that an external surface of the flange second end 106 can include protrusions and/or detents that are engageable with a tool to rotate the firing chamber 100 thereby assisting in the assembling and/or disassembling thereof.

The firing chamber 100 can further define an internal cavity 108 capable of receiving a portion of the cartridge holder 130, with the internal cavity 108 being in communication with the first end bore 104. The internal cavity 108 can include an open end cavity 110, a first transitional cavity portion 112 in communication with the open end cavity 110, an intermediate cavity 114 in communication with the first transitional cavity portion 112, a second transitional cavity portion 116 in communication with the intermediate cavity 114, and a close end cavity 118 in communication with the second transitional cavity portion 116 and the first end bore 104.

The intermediate cavity 114 has a diameter less than a diameter of the open end cavity 110 and/or the close end cavity 118, with the first and second transitional cavity portions 112, 116 having a planar or arcuate profile.

A cartridge cap recess 120 can be defined in the firing chamber 100 adjacent to and in communication with the close end cavity 118. The cartridge cap recess 120 is capable of receiving a primer end 152 of the blasting cartridge 150.

As best illustrated in FIGS. 10 and 11, the cartridge holder 130 can include a through bore 132 defined through the cartridge holder 130 parallel with a longitudinal axis thereof. The through bore 132 is capable of receiving a body of the blasting cartridge 150 with a diameter less than a diameter of the primer end 152, thereby preventing the primer end 152 from passing therethrough. Consequently, the primer end 152 can abut against a first end 134 of the cartridge holder 130.

The cartridge holder 130 can include a flanged portion 136 adjacent the first end 134, an intermediate portion 138 adjacent the flanged portion 136, a transitional portion 140 adjacent the intermediate portion 138, a guide portion 142 adjacent the transitional portion 140, and a flanged end 144 adjacent the guide portion 142.

The first end 134 is capable of traveling through the open end cavity 110 and the intermediate cavity 114 so as to be receivable in the close end cavity 118 of the firing chamber 100 when assembled. The intermediate portion 138 is capable of traveling through the open end cavity 110, and can include external threading or other engagement means engageable with internal threading of the intermediate cavity 114 of the firing chamber 100. The guide portion 142 is capable of being receivable in the open end cavity 110 of the firing chamber 100.

The flanged end 144 can include radial notches 146 that are engageable with teeth 156 of a tool 154 (FIG. 12) such as, but not limited to, a wrench, a socket, pliers and the like. The tool 154 is capable of rotating the cartridge holder 130 thereby assisting in the assembling and/or disassembling thereof.

As best illustrated in FIG. 11, the blasting cartridge 150 is received in the bore 132 of the cartridge holder 130 so that the primer end 152 abuts the first end 134. The first end 134 of the cartridge holder 130 is received in the internal cavity 108 of the firing chamber 100 so that the cartridge holder 130 is joined to the firing chamber 100. The first end 102 of the firing chamber 100, with the assembled cartridge holder 130, is then received in the second end 86 of the lower tube 80.

When assembled, the firing pin 70 can reciprocally move within the hollow interior of the lower tube 80 while being guided by the firing pin guide 90 attached to the firing pin 70. The firing tip 72 can reciprocally move within the first end bore 104 so as to impact the primer end 152 of the blasting cartridge 150.

In FIG. 13, an alternate embodiment of the portable seismic survey system and method 160 of the present technology for reflection seismology intended for mapping subterranean formations is illustrated and will be described. To collect seismic survey data in a field 2 to be surveyed, a plurality (tens, hundreds or thousands) of the ground seismometers 4 can be positioned at predetermined locations in or on the field 2, as described above.

Ground motion can then be created with small explosive charges positioned inside a borehole 3 drilled into the surface of the earth at a variable angle and/or a depth that can be variably determined based on local conditions using an alternate embodiment portable seismic source device 162. The angle of the borehole 3 can be configured to facilitate generation of shear waves. The timing and position of these seismic sources should be very accurate, timed to the fraction of a millisecond, with positions accuracies ranging from with five (5) meters to less than a meter depending on the geophysical acquisition objectives.

It can be appreciated that the alternate seismic device 162 can be used in the same or similar technique as the above described portable seismic survey system and method 10.

Broadly, the seismic source device 162 can include an upper assembly 164, a main tube 320, a lower assembly 330 capable of being inserted into a borehole 3, an adjustable shield clamp assembly 360 including a shield 398 capable of being placed on the ground, a handle and anchor/foot strap assembly 420, and one or more foot straps 460 each capable of receiving a weight, hand or foot 6 of a user. The seismic source device 162 can be in communication with a GPS event marking device 5 that is in communication with a GPS or location antenna mountable to the threaded stud 18, as shown in FIG. 2, at the top of the seismic source device 162. The GPS event marking device 5 can be in communication with the central recording system in real time or event data can be uploaded to the central recording system at a later time.

Referring to FIGS. 14 and 15, the upper assembly 164 can include a tubular housing 166 defining a hollow interior or internal cavity 168, a first end that can be closed off with an attachable end cap 170 or opened, and a second end 180. The first end can include planar surfaces 169 that are engageable with a tool such as, but not limited to, a wrench, a socket, pliers and the like. The tool can be capable of rotating the tubular housing 166 thereby assisting in the assembling and/or disassembling thereof.

The end cap 170 can include a threaded bore 171 configured to receive the threaded stud 18 or a peripheral device. The threaded stud 18 can be threadably engageable with the end cap 170, with an end of the threaded stud 18 being receivable in the hollow interior. The threaded stud 18 can include a hook end for hanging the seismic source device 162 or additional peripheral devices can be threadably attached to the threaded stud 18. The threaded stud 18 can further include a quick release mechanism for fitting the peripheral system and/or the GPS antenna 6 thereto. A jam nut and lock washer can be threadably engaged with the threaded stud 18 to more securely attach the threaded stud 18 in position and prevent rotation thereof.

A pair or more of guide slots 172 can be defined through the tubular housing 166 opposite each other, with the guide slots 172 being in communication with the internal cavity 168. The guide slots 172 can include a first longitudinal slot 174 substantially parallel with a longitudinal axis of the upper assembly 164, a lateral slot 176, and a second longitudinal slot 178 substantially parallel with the first longitudinal slot 174 and with a length less than the first longitudinal slot 174. The second longitudinal slot 178 can have a length less than a length of the first longitudinal slot 174. The guide slots 172 can be in the general shape of the letter “J” or J-slots.

The second end 180 can include an internal annular ledge or groove 182 adjacent to an internal threaded section of the second end 180. The second end 180 can include internal threading or other engagement means.

Referring to FIG. 15, a firing pin actuator 190 can be a firing weight that can have a configuration capable of being slidably receivable in the internal cavity 168 of the upper assembly 164. The firing weight 190 can include a firing pin bore 214 defined centrally or parallel with a longitudinal axis of the firing weight 190. The firing pin bore 214 can be capable of receiving a first end portion of a firing pin 342. The firing weight 190 can further include a first bore 198 configured to receive a post of a handle or knob 200. The post is configured to pass through at least one of the guide slots 172. The knob 200 can include a stop edge having a diameter or width greater than a width of the guide slots 172. The first bore 198 and the post can include threading. It can be appreciated that rotating the knob 200 can create a clamping force to the edges or sides of the tubular housing 166 defining the guide slots 172 between an outer surface of the firing weight 190 and the stop edge of the knob 200, thereby allowing a user to secure or lock the firing weight 190 in place.

It can be appreciated that the firing weight 190 can be in the alternative, but not limited to, a biasing element, a linear drive means or a rotary drive means, which is capable of advancing and/or retracting the firing pin 342.

The firing weight 190 can further include a second bore 202 located opposite the first bore 198, and the first and second bores 198, 202 can be in communication with each other. The second bore 202 can be configured to slidably receive a first end of a sensor holding handle 204. The first end can include a bore 206 defined lateral in relation to a longitudinal axis or length of the sensor holding handle 204. A second end 208 of the sensor holding handle 204 can include an internal cavity 210 capable of receiving and/or retaining at least an end of a detonation sensor 212.

As best illustrated in FIG. 15a, the firing weight 190 can further include a third bore 192 configured to receive a lock pin 194. The third bore 192 can include an internal enlarged section configured to receive a spring 193 positioned externally around a portion of the lock pin 194. The spring 193 can contact a stop edge defined in the internal enlarged section of the third bore 192 and a stop edge defined externally on the lock pin 194, thereby creating a biasing force on the lock pin 194 towards the bore 206 of the sensor holding handle 204, thereby positioning a first end of the lock pin 194 in the bore 206 when it is aligned with the third bore 192 and securing the detonation sensor 212 in place. The lock pin 194 can include a grip, handle or ring 196 extending from a second end thereof. The ring 196 can be utilized to pull the lock pin 194 out of the third bore 192 and/or bore 206 against the biasing force of the spring 193. It can be appreciated that the spring 193 and lock pin 194 arrangement produces a spring-loaded quick coupling assembly for the detonation sensor 212, and provides a keyed mechanism for positioning the detonation sensor 212 in a specific orientation for direction control.

In an alternative, the third bore 192 can include a threaded section that is engageable with an external threaded section of the lock pin 194, thereby securing the lock pin 194 in place. The first end of the lock pin 194 can be configured to be received in the bore 206 of the sensor holding handle 204 when it is aligned with the third bore 192. The grip or ring 196 can be utilized to rotate the lock pin 194, push the lock pin 194 into the third bore 192 and/or bore 206, and/or pull the lock pin 194 out of the third bore 192 and/or bore 206.

The second bore 202 of the firing weight 190 can have a diameter or width greater than the first bore 198, thereby creating a stop edge. The first end of the sensor holding handle 204 can be configured to contact this stop edge to assist in positioning the bore 206 of the sensor holding handle 204 in alignment with the third bore 192 of the firing weight 190.

The firing weight 190 can further include one or more lateral bores 216 that can be defined lateral to and in communication with the firing pin bore 214. A setscrew 218 can be threadably engaged in at least one of the lateral bores 216 so that an end of the setscrew 218 is received in an annular groove 344 defined in a first end portion of the firing pin 342. It can be appreciated that tightening the setscrew 218 against a surface of the groove 344, when the firing pin 342 is inserted in the firing pin bore 214, can lock or clamp the firing pin 342 to the firing weight 190. Consequently, with the firing pin 342 locked in the firing weight 190, it can be appreciated that any lateral or rotational movement of the firing weight 190 results in a similar lateral or rotational movement to the firing pin 342. It can be appreciated that the firing pin 342 can be pitted for nesting of the setscrew 218, or a hole can be defined through the firing pin 342 to receive the setscrew 218, or even still the firing pin 342 can be textured to create a gripping force with the setscrew 218 and/or the surface of the firing weight 190 that defines the firing pin bore 214.

It can be appreciated that the firing pin weight 19 can be in the alternative, but not limited to, a biasing element, a linear drive means or a rotary drive means, which is capable of advancing and/or retracting the firing pin 342.

Referring to FIGS. 16 and 17, an end collar 220 can be utilized with a foot strap mounting collar 300. The end collar 220 can include a flanged end capable of being received or located in the groove 182 defined in the second end 180 of the tubular housing 166. A threaded post 222 can extend from the flanged end, and a bore 224 can be defined through the end collar 220. The bore 224 can be configured to slidably receive a portion of the firing pin 342.

The foot strap mounting collar 300 can include a first end 302 featuring external threading that is engageable with the internal threading of the second end 180 of the tubular housing 166. A bore 314 can be defined through the foot strap mounting collar 300, and the bore 314 can be configured to slidably receive a portion of the firing pin 342. A first end section of the bore 314 adjacent the first end 302 can include internal threading 304 that are engageable with the external threading of the threaded post 222 of the end collar 220.

A first annular flanged section 306 can be adjacent the first end 302 of the foot strap mounting collar 300. The first flanged section 306 can have a diameter or width greater than the first end 302 and at least similar to a diameter or width of the second end 180 of the tubular housing 166. A surface of the first flanged section 306 can contact the second end 180 of the tubular housing 166 when the foot strap mounting collar 300 is assembled to the tubular housing 166.

A second annular flanged section 310 can be spaced apart from the first flanged section 306, to define a first annular groove 308 therebetween. The second flanged section 310 can have a diameter or width less than the first flanged section 306.

Adjacent to the second flanged section 310 can be a second annular groove 311, and then a second end 312. The second end 312 can include external threading engageable with internal threading of a first end 322 of the main tube 320.

One or more setscrews 324 can be threadably engaged in at least one lateral bore defined through the main tube 320 in a direction lateral to a longitudinal axis of the main tube 320 so that an end of the setscrew 324 is received in the second annular groove 311 of the foot strap mounting collar 300. It can be appreciated that tightening the setscrew 324 against a surface of the second annular groove 311, when the main tube 320 is assembly with the in the foot strap mounting collar 300, can lock or clamp the main tube 320 to the foot strap mounting collar 300.

Referring to FIGS. 17 and 18, the handle and foot strap assembly 420 can be attachable to the first annular groove 308 of the foot strap mounting collar 300. The handle and foot strap assembly 420 can include a pair of handle members 422 each featuring a radial or curved recess 424 configured to receive a portion of the first annular groove 308, and a handle 428 extending out therefrom or attachable thereto. A first of the handle members 422 can include one or more fastener bores 426 configured to slidably receive a portion of a handle fastener 432, and a second of the handle members 422 can include one or more threaded fastener bores 430 configured to threadably engage with threads of the handle fastener 432. The handle fastener 432 can be, but not limited to, a screw, bolt, pin, clamp or the like. The handles 428 can further include a plurality of holes defined therethrough, and can have an ergonomic configuration.

Each handle member 422 can be positioned so that their respective recess 424 is received on either side of the first annular groove 308 of the foot strap mounting collar 300 so that the fastener bores 426 of the first handle member are aligned with the threaded fastener bores 430 of the second handle member. The handle fastener 432 can be inserted through each of the fastener bores 426 and then threadable engaged with the threaded fastener bores 430, thereby clamping the handle members 422 to the first annular groove 308 of the foot strap mounting collar 300. At least one of the handle members 422 can be configured to create a gap between the handle members 422 when assembled on the first annular groove 308 of the foot strap mounting collar 300. It can be appreciated that the handle members 422 can be clamped to any part of the tubular housing 166 or main tube 320.

It can further be appreciated that the threaded fastener bores 430 can be smooth, without threading, and the handle fastener 432 can be a bolt that passes through both bores 426, 430 with the utilization of a nut on the bolt to squeeze the handle members 422 together. Other clamping, squeezing or fastening means can be utilized, in place of the handler fastener 432 and in the spirit of the present technology, to squeeze the handle members 422 together.

At least one strap mount 440 can be pivotably received in the gap defined between the assembled handle members 422. Each strap mount 440 can include a first bore 442, and a second bore 444. The first bore 442 can be configured to receive the handle fastener 432 therethrough allowing the strap mount 440 to rotate about the handle fastener 432. The second bore 444 can be configured to receive a portion of, in the exemplary, a ring or carabiner 446. It can be appreciated that the carabiner 446 can be any type of connector or link allowing for articulate movement and connection between a strap 448 and the strap mount 440.

Referring now to FIGS. 19 and 20, the adjustable shield clamp assembly 360 can be adjustably positioned along the main tube 320. The shield clamp assembly 360 can include a shield handle 362, a first shield clamp member 370, a second shield clamp member 380, and a shield 398. The shield handle 362 can include a main tube slot or hole 364 configured to slidably receive the main tube 320 therethrough. The shield handle 362 can include multiple sections transitioning to form a configuration capable of being grasped by a user, and attached to the first or second shield clamp member 370, 380. The section of the shield handle 362 including the hole 364 can be perpendicular or angled in a relation to the section of the shield handle 362 that is mounted to the second shield clamp member 380.

The first shield clamp member 370 can include a clamp block end 372, a radial or curved recess 374 configured to receive a portion of the main tube 320, and a flanged second end 376. The clamp block end 372 can include one or more fastener bores 375 configured to slidably receive a portion of a clamp fastener 410. The flanged second end 376 can include one or more threaded bores 378 configured to receive and engage with a shield fastener 396 received through the shield 398. The shield 398 can be secured to the flanged second end 376 by tightening the shield fastener 396.

The second shield clamp member 380 can include a clamp block end 382, a radial or curved recess 384 configured to receive a portion of the main tube 320, and a flanged second end 388. The clamp block end 382 of the second shield clamp member 380 can include one or more threaded bores 392 configured to receive and engage with a handle fastener 394 received through a section of the shield handle 362. The shield handle 362 can be secured to the clamp block end 382, for example by tightening the handle fastener 394. Further, the clamp block end 382 of the second shield clamp member 380 can include one or more threaded fastener bores 386 configured to threadably engage with threads of the clamp fastener 410.

The flanged second end 388 can include one or more threaded bores 390 configured to receive and engage with a shield fastener 396 received through the shield 398. The shield 398 can be secured to the flanged second end 388 by tightening the shield fastener 396.

A main tube bore 399 can be defined through the shield 398 to receive the main tube 320 therethrough, or the shield 398 can be configured in multiple sections each with a curved recess configured to receive a portion of the main tube 320.

Each shield clamp member 370, 380 can be positioned so that their recess 374, 384 is received on either side of the main tube 320 so that the fastener bores 375 of the first shield clamp member 370 are aligned with the threaded fastener bores 386 of the second shield clamp member 380. The clamp fastener 410 can be inserted through each of the fastener bores 375 and then threadable engaged with the threaded fastener bores 386, thereby clamping the first and second shield clamp members 370, 380 to the main tube 320.

Each clamp fastener 410 can be associated with a cam lock 400 having a pair of walls 402 each featuring a curved or cam surface 404. The walls 402 are spaced apart to form a gap 403 therebetween. The cam surface 404 is configured to engage with or contact a side surface of the clamp block end 372 of the first shield clamp member 370 in a first position, and provide a space between the cam surface 404 and the side surface of the clamp block end 372 in a second position. Cam handle 406 can be attached to the cam lock 400 allowing a user to manipulate the cam lock 400.

A cam pin 408 can be received through the walls 402 so as to extend into or through the gap 403. Each clamp fastener 410 can include a cam end 412 defining a bore therethrough configured to receive the cam pin 408. The cam end 412 is positioned in the gap 403 between the walls 402, consequently transferring any rotational, lateral or longitudinal motion of the cam lock 400 to the clamp fastener 410.

With the first and second shield clamp members 370, 380 assembled on the main tube 320, and the clamp fasteners 410 received through the fastener bores 375 and engaged in the threaded fastener bores 386, it can be appreciated that rotating the cam handle 406 would rotate the clamp fastener 410 thereby tightening the clamp fastener 410. It can further be appreciated that placing the cam lock 400 in the second position would relieve a clamping force on the first clamp member 370 thereby removing a clamping force against the main tube 320, consequently allowing the shield clamp assembly 360 to slide along the main tube 320 to adjust its position therealong. Adjusting the position of the shield clamp assembly 360 on the main tube 320 allows the user to adjust the height of the shield 398 in relation to the lower assembly 330, and consequently allowing the user to adjust the depth the lower assembly 330 is in the borehole 3 when in operation.

Rotating the cam lock 400 to the first position would rotate the cam surface 404 to contact the side surface of the clamp block end 372 or a washer in contact with the clamp block end, thereby creating a clamping force that consequently brings the first and second clamp members 370, 380 together. This clamping force results in a clamping the first and second clamp members 370, 380 to the main tube 320. The cam lock 400 can be appreciated as being a quick-lock or quick-release assembly.

It can further be appreciated that the threaded fastener bores 386 can be smooth, without threading, and the clamp fasteners 410 can be a bolt that passes through both bores 375, 386 with the utilization of a nut on the bolt to squeeze the first and second shield clamp members 370, 380 together. Other clamping, squeezing or fastening means can be utilized, in place of the clamp fasteners 410 and in the spirit of the present technology, to squeeze the first and second shield clamp members 370, 380 together.

Referring to FIG. 21, the lower assembly 330 can include a lower tube assembly 332, and a cartridge holder 350. A blasting cartridge 150 can be loadable in an end, cavity or bore of the cartridge holder 350. The lower tube assembly 332 can include a lower tube 334, and a firing chamber 338. The lower tube 334 can define a longitudinal firing pin bore 335 therethrough configured to slidably receive at least a firing tip 346 of the firing pin 342, and can have a configuration that guides the firing pin 342 during movement. An end of the lower tube 334 can be chamfered or beveled to assist in entering the firing tip 346 into the firing pin bore 335. The lower tube 334 can include an externally threaded section 336 configured to engage with an internally threaded section 326 associated with a second end of the main tube 320. The lower tube 334 can be configured to be received in a hollow interior 328 of the main tube 320.

A stop edge 337 can be provided at a location where the lower tube 334 transitions to the firing chamber 338. When the lower tube is assembled to the main tube 320, the stop edge 337 can contact the second end of the main tube 320 to provide a secure fit and/or prevent further insertion of the lower assembly 330 into the main tube 320.

The firing chamber 338 can include an internal cavity 339 configured to receive a first portion or first end 352 of the cartridge holder 350. The first end 352 can include an externally threaded section that is engageable with an internally threaded section 340 in the internal cavity 339 of the firing chamber 338. This allows the cartridge holder 350 to securely attach to or be removed from the firing chamber 338.

The cartridge holder 350 can include a flanged end 354 creating a stop edge 356 that can contact a free end of the firing chamber 338. The first end 352 is capable of traveling through the internal cavity 339 so as to be receivable in the firing chamber 338 when assembled. The flanged end 354 can include notches or planar surfaces that are engageable by a tool capable of rotating the cartridge holder 350 thereby assisting in the assembling and/or disassembling thereof.

As best illustrated in FIG. 21, the blasting cartridge 150 is received in a bore of the cartridge holder 350 so that a primer end of the blasting cartridge 150 is adjacent the firing pin bore 335. A free edge associated with the first end 352 is configured to secure or clamp the primer end of the blasting cartridge 150 to an end surface of the firing chamber 338 that in part defines the internal cavity 339, thereby holding the blasting cartridge 150 in place during detonation. The first end 352 of the cartridge holder 350 is received in the internal cavity 339 of the firing chamber 338 so that the cartridge holder 350 is joined to the firing chamber 338, which is mounted to the second end of the main tube 320 by way of the lower tube 334.

When assembled, the firing pin 342 can reciprocally move within the firing pin bore 335 upon movement of the firing weight 190. The firing tip 346 can reciprocally move within the firing pin bore 335 to strike the primer end of the blasting cartridge 150.

Referring to FIG. 22, a second carabiner 452 can be utilized to connect the strap 448 to a foot strap buckle 454. It can be appreciated that the second carabiner 452 can be any type of connector or link allowing for articulate movement and connection between the strap 448 and the foot strap buckle 454. The strap 448 can include a tightening or ratcheting means 450, as best illustrated in FIG. 13. The ratcheting means 450 can be configured to change the length of the strap 448 between the first and second carabiners 446, 452.

The foot strap buckle 454 can include a first slot 456 configured to receive a portion of the second carabiner 452, and one or more foot strap slots 458 configured to receive an anchor or foot strap 460 therethrough. A length of the foot strap 460 can be adjustable, and can be in the form of a stirrup capable of receiving a foot 6 of a user.

A hold down or lifting force can be provided to the strap 448 directly or via the foot strap 460. The hold down force can be provided by the user placing a foot 6 into the foot strap 460, adjust a length of the strap 448 so as to support a weight of the user. The weight of the user can be provided to the upper assembly 164 or the main tube 320 via the strap 448, thereby holding down the device 162 during operation and/or detonation. The lifting force can be provided the upper assembly 164 or the main tube 320 by the user or machine lifting up on strap 448 and/or the foot strap 460, thereby lifting the device 162.

The foot strap 460 can be replaced with a ground anchor such as but not limited to a stake, auger, mooring, weight and the like. Still further, the device 162 can be mounted to a vehicle.

It can be appreciated that any component, assembly or element of the alternate portable seismic system 160 can include any or all of the alternatives, additions or advantages of the above described portable seismic system 10.

In use, it can now be understood that at least one borehole 3 is drilled below the surface of the earth 2. Ground seismometers 4 are positioned at predetermined locations in or on the field 2 at locations associated with the borehole 3. The present technology can be used, but not limited to, oil and gas exploration, geotechnical work associated with engineering bridges, pipelines, roadways, tunnels and the like. Imaging of caprock and the underlying reservoir(s) associated with SAGD production is also envisioned for possible uses of the present technology.

A user would insert the blasting cartridge into the cartridge holder with its primer end abutting the first end of the cartridge holder. The cartridge holder can then be coupled to the firing chamber. A tool or wrench can be used to assist in engaging the cartridge holder with the firing chamber.

For safety, the user could position and retain the ends of the first and second actuator handles or the knob and sensor holding handle in their respective lateral slot or second longitudinal slot, respectively, so that the firing weight and firing pin are in a non-operable position. The detonation sensor is secured to the second actuator handle and the piezo holder, or the sensor holding handle, respectively.

While in this non-operable position, the firing chamber can then be coupled to the second end of the lower tube, the lower tube assembly can be connected to the main tube, with the firing tip adjacent or received in the first end bore, or firing pin bore of the firing chamber, respectively. A tool or wrench can be used to assist in engaging the assembled firing chamber and cartridge holder with the lower tube or the main tube.

The lower assembly of the seismic source device 12, 162 can then be inserted into the borehole 3 so that it is in a substantially vertical orientation. Utilizing the seismic source device 12, the user can then stand on the foot support assembly, and can grasp as least one of the handles. Utilizing the alternate seismic source device 162, the user can adjust the position of the shield to contact the ground, and then stand on the shield or place one foot in one of the foot straps while standing. The weight of the user would act as an anchor to the alternate seismic source device 162 during detonation. The user could place both feet in separate foot straps, or more than one user can place at least one foot in a foot strap. The length of the strap connecting the foot strap to the handle and foot strap assembly can be adjusted to provide sufficient weight on the alternate seismic source device 162.

When ready, the user can operate the switch to allow communication from the detonation sensor to the GPS event marking device, and then move the first and/or second actuator handles, or the knob and/or sensor holding handle, so they are moved out of their respective lateral or second longitudinal slot and into their respective longitudinal slot. In this operable position, the first and/or second actuator handles, or the knob and/or sensor holding handle, are free to drop or travel along the longitudinal slot, due to gravity and the weight of the firing weight or any other driving force.

As the firing weight drops, it simultaneously moves the firing pin toward the firing chamber until the firing tip strikes the primer end of the blasting cartridge, thereby detonating the blasting cartridge inside the borehole. Upon contact, the blasting cartridge is detonated thereby creating a seismic wave that propagates from inside the borehole and through the earth until it is reflected and refracted off of subsurface geological layers in the field 2.

The detonation sensor detects the detonation of the blasting cartridge and generates a voltage or signal to the GPS event marking device 5. The GPS event marking device 5 is then triggered by this signal from the detonation sensor to record the precise time (T=0) and geographical location of detonation. Detonation time (T=0) can be recorded with sub-millisecond accuracy. It can be appreciated that the detonation sensor triggers and controls the operation of the GPS event marking device 5, and not the GPS event marking device 5 controlling the time of detonation. It can be appreciated that blasting cartridge can be engineered with a delay, in which case the known delay can be added to the detonation time signaled by the detonation sensor to provide a more accurate adjusted detonation time (T=0).

The reflected and refracted waves travel back toward the ground seismometers 4, which may also be equipped with GPS units that record reception time and/or geographical location. Detonation time from the GPS event marking device 5 and reception times from the seismometers 4 can be communicated, along with geographical locations, to the central recording system to be correlated. The central recording system can then process detonation time and location, and reception times and locations, to provide geological formation information.

Alternatively, the second end of the main tube and the first end of the lower tube can be associated with a bearing, and a drive means can be coupled to the lower tube so as to rotate the lower tube in relation to the main tube. The lower tube or the cartridge holder can further include a drilling bit or teeth means that is capable of drilling into the ground. Thus combining a drilling means with the lower assembly.

The system, process and/or method of the present technology can include at least one computer configured or configurable for automated and/or controlling operations of any of the components in the present technology. The computer system can include one or more processors, memory, input and output device, display, and communication systems for transmitted and receiving data, along with sensors to temperature, pressure, vibration, energy or power consumption, energy or power generation, environmental conditions, material composition, and the like.

A database can be included which stores information on all solvents utilizable in the system, regulatory information for geographic locations, and/or information related to soil types. The database can be accessible by software for information retrieval. The software could then retrieve all required information from the database, process the information, and provide system control data to the operator. The software can be configured or configurable to provide automated control of any of the components of the present technology based on the entered data, the retrieved date, sensor data, and/or updated data.

In various example embodiments, the seismic source device 12, 162 can operate as a standalone device or may be connected (e.g., networked) to other devices. In a networked deployment, the seismic source device may operate in the capacity of a server or a client machine in a server-client network environment, or as a peer machine in a peer-to-peer (or distributed) network environment. The seismic source device may include or be in communication with a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that device. Further, while only a single seismic source device is illustrated, the term “device” shall also be taken to include any collection of devices that individually or jointly execute a set (or multiple sets) of instructions to perform any one or more of the methodologies discussed herein.

The example seismic source device 12, 162 can include a processor or multiple processors (e.g., CPU, GPU, or both), and a main memory and/or static memory, which communicate with each other via a bus. In other embodiments, the seismic source device 12, 162 may further include a video display (e.g., a liquid crystal display (LCD)). The seismic source device 12, 162 may also include an alpha-numeric input device(s) (e.g., a keyboard), a cursor control device (e.g., a mouse), a voice recognition or biometric verification unit (not shown), a drive unit (also referred to as disk drive unit), a signal generation device (e.g., a speaker), a universal serial bus (USB) and/or other peripheral connection, and a network interface device. In other embodiments, the seismic source device 12, 162 may further include a data encryption module (not shown) to encrypt data.

The seismic source device 12, 162 may include a module operably associated with a drive unit, with the drive unit including a computer or machine-readable medium on which is stored one or more sets of instructions and data structures (e.g., instructions) embodying or utilizing any one or more of the methodologies or functions described herein. The instructions may also reside, completely or at least partially, within the memory and/or within the processors during execution thereof by the seismic source device 12, 162. The memory and the processors may also constitute machine-readable media.

The instructions may further be transmitted or received over a network via the network interface device utilizing any one of a number of well-known transfer protocols (e.g., Extensible Markup Language (XML)). While the machine-readable medium is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the seismic source device 12, 162 and that causes the seismic source device to perform any one or more of the methodologies of the present technology, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

It is appreciated that the software application may be configured or configurable to be stored in any memory of the seismic source device 12, 162 or on a remote computer in communication with the seismic source device 12, 162.

It can further be appreciated that the lower assembly can include an automatic blasting cartridge loading means, which is capable of removing a spent blasting cartridge and loading a new blasting cartridge for subsequent use. The seismic source device 12, 162 can further include a holding device capable of holding one or more blasting cartridges. The firing pin can have a configuration capable of simultaneously detonating several blasting cartridges, some of which would have different orientations (vertical, lateral, etc.).

Still further, it can be appreciated that the seismic source device 12, 162 can include a spirit (bubble) level or an electronic level having a configuration capable of indicating an angle of the device relative to the earth's nadir.

Even still further, it can be appreciated that all the above described threading engagements can be replaced with any mechanical engagement means such as, but not limited to, ratchets, clips, clasps, magnetics, tabs, keys, wedges, press fit surfaces, adhesives, welding and the like. Additionally, any or all transitional edges can be chamfered or beveled.

While embodiments of the portable seismic survey system and method have been described in detail, it should be apparent that modifications and variations thereto are possible, all of which fall within the true spirit and scope of the present technology. With respect to the above description then, it is to be realized that the optimum dimensional relationships for the parts of the present technology, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present technology. For example, any suitable sturdy material may be used.

Therefore, the foregoing is considered as illustrative only of the principles of the present technology. Further, since numerous modifications and changes will readily occur to those skilled in the art, it is not desired to limit the present technology to the exact construction and operation shown and described, and accordingly, all suitable modifications and equivalents may be resorted to, falling within the scope of the present technology.

What is claimed as being new and desired to be protected by Letters Patent of the United States is as follows:

1. A seismic system comprising:
a firing pin operably associated with a firing pin actuator slidable in an upper assembly;
a lower assembly including a cartridge holder configured to retain a blasting cartridge so that said firing pin operationally detonates the blasting cartridge;
a main tube connecting said upper assembly and said lower assembly, said main tube being configured to position said upper assembly out of a borehole and to position said cartridge holder in the borehole; and
a shield assembly configured to adjustably move along said main tube.

2. The seismic system of claim 1, wherein said shield assembly further comprising a shield attachable to a shield clamp member, and a shield handle attachable to said shield clamp member.

3. The seismic system of claim 2, wherein said shield clamp member is configured to releasably clamp against said main tube.

4. The seismic system of claim 2, wherein said shield handle includes an opening configured to slidably receive said main tube.

5. The seismic system of claim 1 further comprising at least one detonation sensor operably connected with said firing pin actuator, said detonation sensor is configured to detect a detonation condition of the blasting cartridge.

6. The seismic system of claim 5, wherein said upper assembly defines at least one J-shaped slot configured to slidably receive a portion of a sensor holder including said detonation sensor.

7. The seismic system of claim 5, wherein said firing pin actuator defining a lock pin bore and a sensor bore, said lock pin bore being configured to receive a lock pin biased toward a sensor holder, said sensor holder being configured to receive said detonation sensor and to be received in said sensor bore.

8. The seismic system of claim 5, wherein said firing pin actuator defining a firing pin bore configured to receive a first end portion of said firing pin, and at least one setscrew bore defined through said firing pin actuator lateral and in communication with said firing pin bore, and wherein a setscrew is receivable in said setscrew bore and configured to contact an annular groove defined in said firing pin when said first end portion of said firing pin is located in said firing pin bore.

9. The seismic system of claim 5 further comprising:
at least one event marking device in communication with said detonation sensor, said event marking device is configured to determine a detonation time and a geographic location of said seismic system upon receipt of a signal from said detonation sensor of a detonation condition of the blasting cartridge; and
at least one seismometer configured to detect a seismic condition created by the detonation condition of the blasting cartridge.

10. The seismic system of claim 1 further comprising one or more anchors tethered to said upper assembly or said main tube by way of a strap, said anchor being configured to provide a hold down force or a lifting force to said upper assembly or said main tube.

11. The seismic system of claim 10 further comprising a mounting collar including a longitudinal bore configured to slidably receive said firing pin therethrough, a mounting collar first end connectable to a second end of said upper assembly, and a mounting collar second end connectable to a first end of said main tube.

12. The seismic system of claim 11 further comprising an anchor mount assembly including an anchor clamp member, at least one handle extending from or attachable to said anchor clamp member, and at least one strap mount rotatably or pivotably connectable to said anchor clamp member, said strap being operably connected to said strap mount and said anchors, respectively.

13. The seismic system of claim 12, wherein said anchor clamp member is configured to releasably clamp against said mounting collar.

14. The seismic system of claim 10, wherein said anchors are a strap or loop configured to receive a foot or hand of a user.

15. The seismic system of claim 1 further comprising a lower tube attachable to said main tube, said lower tube including a first end section configured to receive and guide at least a portion of said firing pin, and a firing chamber configured to receive at least a portion of said cartridge holder.

16. A seismic system comprising:
a firing pin operably associated with a firing pin actuator slidable in an upper assembly;
a lower assembly including a cartridge holder configured to retain a blasting cartridge so that said firing pin operationally detonates the blasting cartridge;
a main tube connecting said upper assembly and said lower assembly, said main tube being configured to position said upper assembly out of a borehole and to position said cartridge holder in the borehole; and
an anchor assembly associated with said upper assembly or said main tube, said anchor assembly being configured to provide a hold down force or a lifting force to said upper assembly or said main tube.

17. The seismic system of claim 16 further comprising a shield assembly configured to adjustably move along said main tube, said shield assembly including a shield attachable to a shield clamp member, and a shield handle attachable to said shield clamp member, said shield clamp member is configured to releasably clamp against said main tube.

18. The seismic system of claim 17, wherein said shield handle including an opening configured to slidably receive said main tube.

19. The seismic system of claim 16, wherein said firing pin actuator comprising a firing pin bore configured to receive a first end portion of said firing pin, and at least one setscrew bore defined through said firing pin actuator lateral and in communication with said firing pin bore, and wherein a setscrew is receivable in said setscrew bore and configured to contact an annular groove defined in said firing pin when said first end portion of said firing pin is located in said firing pin bore.

20. The seismic system of claim 16, wherein said anchor assembly including one or more anchors tethered to said upper assembly or said main tube by way of a strap, said anchor assembly is configured to provide the hold down force to said upper assembly or said main tube when a weight is applied to said anchors, respectively.

21. The seismic system of claim 20, wherein said anchor assembly further comprising a mounting collar including a longitudinal bore configured to slidably receive said firing pin therethrough, a mounting collar first end connectable to a second end of the upper assembly, and a mounting collar second end connectable to a first end of said main tube.

22. The seismic system of claim 21, wherein said anchor assembly further comprising an anchor mount assembly including an anchor clamp member, at least one handle extending from or attachable to said anchor clamp member, and at least one strap mount rotatably or pivotably connectable to said anchor clamp member, said strap being operably connected to said strap mount and said anchors, respectively.

23. The seismic system of claim 16 further comprising a lower tube attachable to said main tube, said lower tube including a first end section configured to receive and guide at least a portion of said firing pin, and a firing chamber configured to receive at least a portion of said cartridge holder.

24. The seismic system of claim 16 further comprising at least one detonation sensor operably connected with said firing pin actuator, said detonation sensor is configured to detect a detonation condition of the blasting cartridge.

25. The seismic system of claim 24 further comprising:
at least one event marking device in communication with said detonation sensor, said event marking device is configured to determine a detonation time and a geographic location of said seismic system upon receipt of a signal from said detonation sensor of a detonation condition of the blasting cartridge; and
at least one seismometer configured to detect a seismic condition created by the detonation condition of the blasting cartridge.

26. A method of using a seismic system comprising the steps of:
a) inserting a lower assembly of a seismic device into a borehole, with an upper assembly being connected to said lower assembly by way of a main tube;
b) adjusting a position of a shield assembly along said main tube so that a cartridge holder associated with said lower assembly is at a depth in the borehole;
c) operating a firing pin actuator that is slidably located in an upper assembly of said seismic device to move a firing pin;
d) detonating a blasting cartridge positioned inside said cartridge holder using said firing pin;
f) detecting detonation of the blasting cartridge using a detonation sensor; and
g) transmitting a signal from said detonation sensor to an event marking device that is configured to record a detonation time and a geographic location of said seismic device upon receipt of the signal.
